(19) United States
(12) Patent Application Publication
(10) Pub. No.: US 2016/0319591 A1
(43) Pub. Date: Nov. 3, 2016

(54) Light Input-Adjustable Window Shade

(71) Applicant: Li-Ming Cheng, Kaohsiung City (TW)

(72) Inventor: Li-Ming Cheng, Kaohsiung City (TW)

(21) Appl. No.: 14/700,199

(22) Filed: Apr. 30, 2015

(51) Int. Cl. E06B 9/24; E06B 9/40

(52) U.S. Cl. CPC E06B 9/24; E06B 9/40; E06B 2009/2405; E06B 2009/2447

(57) ABSTRACT

A light input-adjustable window shade includes a supporting member. A spool unit is mounted to the supporting member and includes a first spool and a second spool. An end of a first shade is fixed to the first spool. The first shade can be unfolded or folded through operation of a first transmission and coiling device. An end of a second shade is fixed to the second spool. The second shade can be unfolded or folded through operation of a second transmission and coiling device. The first shade includes at least one first sparsely textured portion. The second shade includes at least one first densely textured portion. At least a portion of the at least one first densely textured portion is located relative to the at least one first sparsely textured portion.

### BACKGROUND OF THE INVENTION

1. Field of the Invention

The present invention relates to a window shade and, more particularly, to a light input-adjustable window shade.

2. Description of the Related Art

Doors and windows in living environments are generally provided with window shades to adjust the amount of sunlight entering the rooms to adjust the indoor brightness.

FIG. 1 shows a front view of a conventional light input-adjustable window shade 9. The conventional light input-adjustable window shade 9 includes a track unit 91, a first shade 92, and a second shade 93. The track unit 91 includes an upper track 911 and a lower track 912. The first shade 92 and the second shade 93 are mounted between the upper track 911 and the lower track 912. The conventional light input-adjustable window shade 9 further includes a pull cord 94 for moving the lower track 912 upward towards the upper track 911 or downwards away from the upper track 911, thereby folding or unfolding both of the first shade 92 and the second shade 93 while adjusting the area of the door or window covered by the first shade 92 and the second shade 93. The first shade 92 includes a plurality of first densely textured portions 921 and a plurality of first sparsely textured portions 922 alternating with the first densely textured portions 921. The second shade 93 includes a plurality of second densely textured portions 931 and a plurality of second sparsely textured portions 932 alternating with the second densely textured portions 931.

A user can operate the pull cord 94 to make both of the first shade 92 and the second shade 93 in a state (not shown) not covering the window to provide a bright indoor environment, or in another state completely covering the window. Furthermore, the relative position between the first shade 92 and the second shade 93 can be adjusted (namely, the second shade 93 can be moved in a transverse direction along the upper track 911 and the lower track 912), such that the first densely textured portions 921 respectively align with the second densely textured portions 931 and such that the first sparsely textured portions 922 align with the second sparsely textured portions 932. Thus, the outdoor sunlight enters indoors via the aligned first and second sparsely textured portions 922 and 932 to reduce the indoor brightness. FIG. 2a shows that the first sparsely textured portions 922 align with the second sparsely textured portions 932, and the outdoor sunlight enters indoors via the aligned first and second sparsely textured portions 922 and 932 (as indicated by the phantom lines) and becomes weaker.

Furthermore, the user can make the first densely textured portions 921 to respectively align with the second sparsely textured portions 932 and can make the first sparsely textured portions 922 to respectively align with the second densely textured portions 931. Thus, the outdoor sunlight that could have passed through the first sparsely textured portions 922 and the second sparsely textured portions 932 are blocked by the second densely textured portions 931 and the first sparsely textured portions 921, reducing the light input and, hence, reducing the indoor brightness. Note that FIG. 2b only illustrates alignment of the first densely textured portions 921 and the second sparsely textured portions 932, and the outdoor sunlight could not enter indoors as being blocked by the first densely textured portions 921.

Furthermore, the user can fold a portion of each of the first shade 92 and the second shade 93 to reduce the area of the door or window covered by the window shade. The first shade 92 and the second shade 93 do not cover a lower portion of the door or window, such that an indoor area adjacent to the door or window is brighter. In this case, the relative position between the first shade 92 and the second shade 93 can be adjusted (namely, the second shade 93 is moved in the transverse direction along the upper track 911 and the lower track 912) to make the first densely textured portions 921 respectively align with the second densely textured portions 931 and to make the first sparsely textured portions 922 align with the second sparsely textured portions 932, such that the outdoor sunlight passing through the upper portion of the door or window can enter indoors via the aligned first and second sparsely textured portions 922 and 932, adjusting the brightness of the indoor area distant to the door or window to a desired extent (see FIG. 2c). Alternatively, the first densely textured portions 921 can align with the second sparsely textured portions 932 and the first sparsely textured portions 922 can align with the second densely textured portions 931, such that the outdoor sunlight passing through the upper portion of the door or window cannot enter indoors as being blocked by the first densely textured portions 921 and the second densely textured portions 931. As a result, the indoor area distant to the door or window has a low brightness. FIG. 2d only shows that the first densely textured portions 921 align with the second sparsely textured portions 932 and that the outdoor sunlight cannot enter indoors as being blocked by the first densely textured portions 921.

However, the user cannot adjust the conventional light input-adjustable window shade 9 to maintain the indoor area distant to the door or window in a low brightness while adjusting the brightness of the indoor area adjacent to the door or window. Thus, improvement to the conventional light input-adjustable window shade 9 is needed.

### SUMMARY OF THE INVENTION

An objective of the present invention is to provide a light input-adjustable window shade capable of maintaining the indoor area distant to the door or window in a low brightness while adjusting the brightness of the indoor area adjacent to the door or window.

A light input-adjustable window shade according to the present invention includes a supporting member having two ends opposite to each other. A spool unit is mounted to the two ends of the supporting member and includes a first spool and a second spool. A first shade includes an end fixed to the first spool. The first shade is unfoldable in an unfolding direction through operation of a first transmission and coiling device or foldable in a folding direction through operation of the first transmission and coiling device. A second shade includes an end fixed to the second spool. The second shade is unfoldable in the unfolding direction through operation of a second transmission and coiling device or foldable in the folding direction through operation of the second transmission and coiling device. The first shade includes at least one first sparsely textured portion. The second shade includes at least one first densely textured portion. At least a portion of the at least one first densely textured portion is located relative to the at least one first sparsely textured portion.

The light input-adjustable window shade can further include a first weight fixed to another end of the first shade and a second weight fixed to another end of the second shade.

The second weight can include a slit. The first shade extends through the slit.

The second weight can include a gripping portion. The slit is located between the gripping portion and the second shade.

The supporting member can include a chamber. The first and second spools are rotatably received in the chamber.

The supporting member can further include an opening intercommunicating the chamber with an outside. Each of the first and second shades is unfoldable in the unfolding direction via the opening and is foldable in the folding direction via the opening.

In an embodiment, the at least one first sparsely textured portion of the first shade includes a plurality of first sparsely textured portions. The first shade further includes a plurality of second densely textured portions. The plurality of first sparsely textured portions alternates with the plurality of second densely textured portions in a stripe arrangement.

In an embodiment, the at least one first densely textured portion of the second shade includes a plurality of first densely textured portions. The second shade further includes a plurality of second sparsely textured portions. The plurality of first densely textured portions alternates with the plurality of second sparsely textured portions in a stripe arrangement.

The plurality of first densely textured portion and the plurality of second sparsely textured portions of the second shade can be respectively located relative to the plurality of first sparsely textured portions and the plurality of second densely textured portions of the first shade.

The present invention will become clearer in light of the following detailed description of illustrative embodiments of this invention described in connection with the drawings.

### BRIEF DESCRIPTION OF THE DRAWINGS

The illustrative embodiments may best be described by reference to the accompanying drawings where:

FIG. 1 is a front view of a conventional light input-adjustable window shade.

FIGS. 2a, 2b, 2c, and 2d are partial, cross sectional views of the conventional light input-adjustable window shade, illustrating different use states.

FIG. 3 is an exploded, perspective view of an exploded, perspective view of a light input-adjustable window shade of a first embodiment according to the present invention.

FIG. 4 is a cross sectional view of the light input-adjustable window shade of FIG. 3.

FIG. 5a is a front view of a use state the light input-adjustable window shade of the first embodiment according to the present invention.

FIG. 5b is a cross sectional view of the light input-adjustable window shade of FIG. 5a.

FIG. 6a is a front view illustrating another use state of the light input-adjustable window shade of the first embodiment according to the present invention.

FIG. 6b is a cross sectional view of the light input-adjustable window shade of FIG. 6a.

FIG. 7a is a front view illustrating a further use state of the light input-adjustable window shade of the first embodiment according to the present invention.

FIG. 7b is a cross sectional view of the light input-adjustable window shade of FIG. 7a.

FIG. 8 is an exploded, perspective view of a light input-adjustable window shade of a second embodiment according to the present invention.

FIG. 9 is an exploded, perspective view of a light input-adjustable window shade of a third embodiment according to the present invention.

FIG. 10 is an exploded, perspective view of a light input-adjustable window shade of a fourth embodiment according to the present invention.

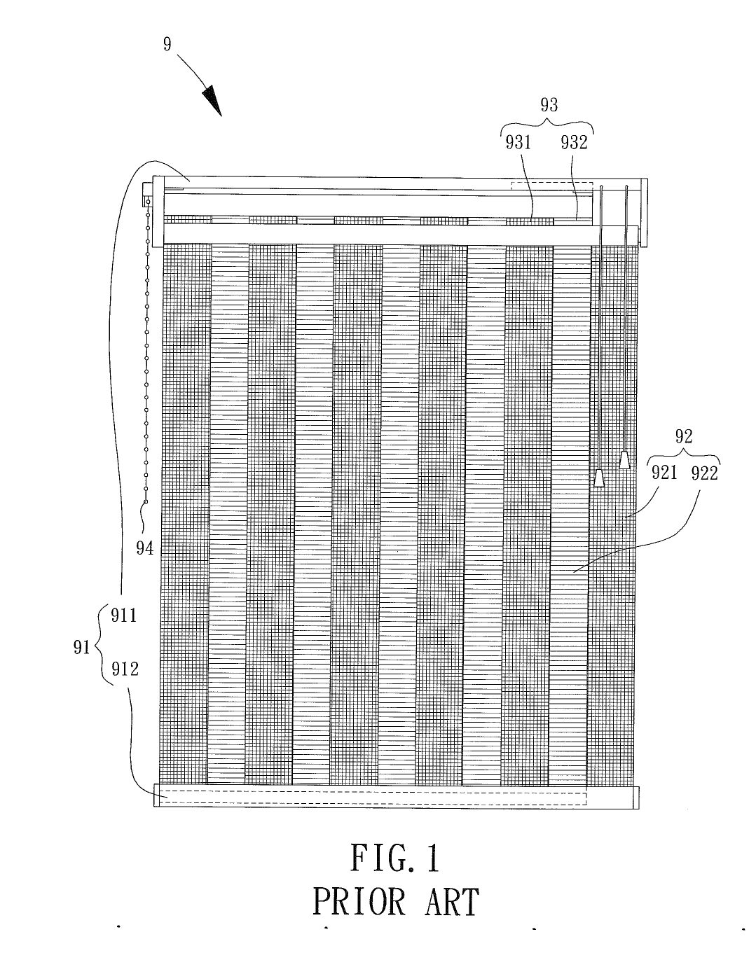

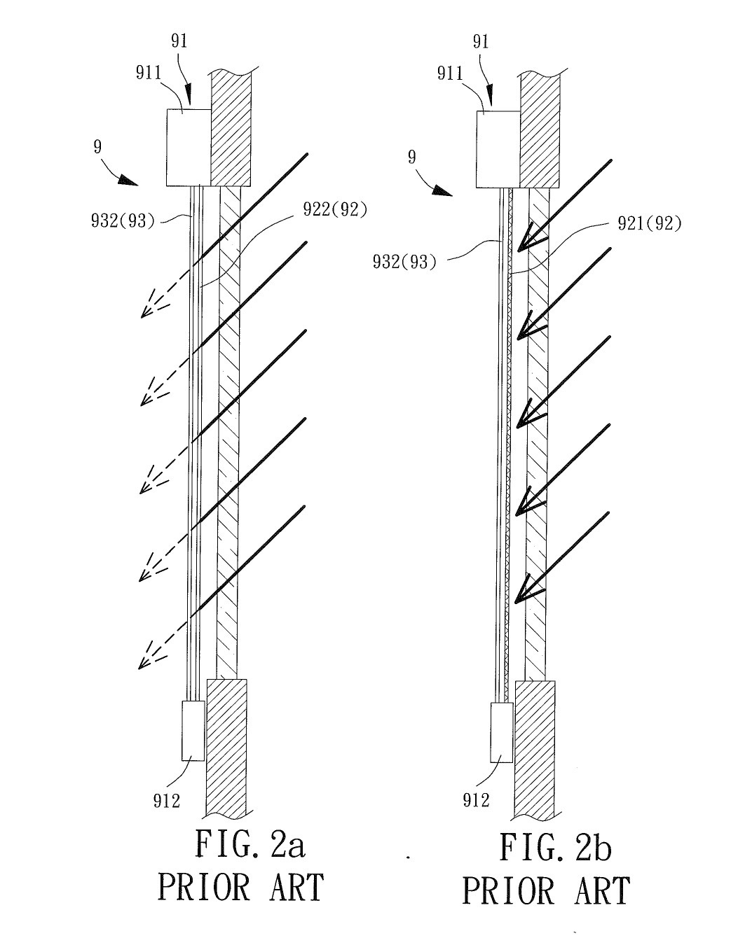

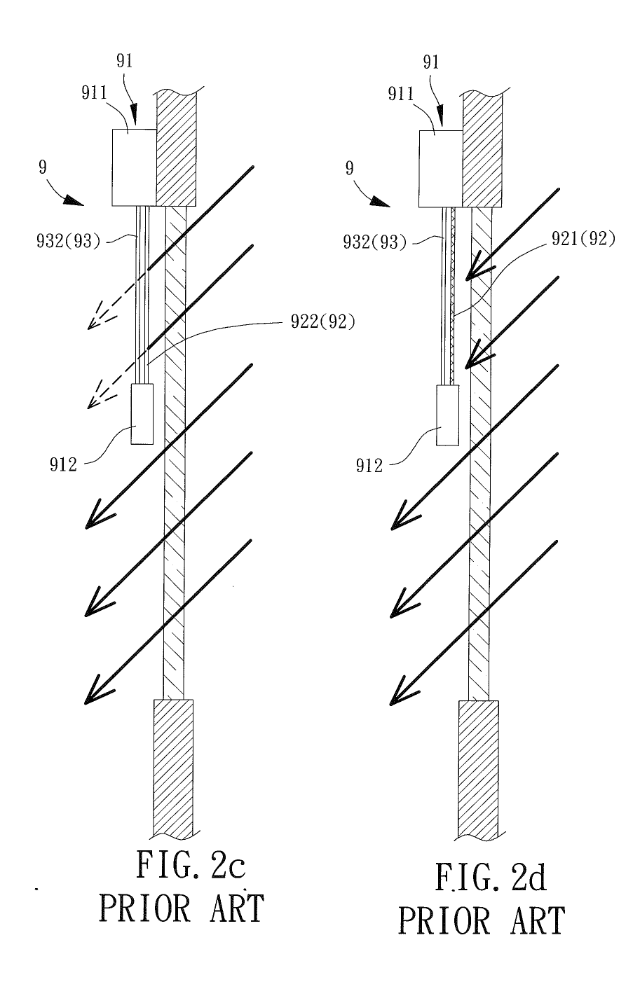

### DETAILED DESCRIPTION OF THE INVENTION

The term “sparsely textured portion of a window shade” used herein refers to a portion of a window shade capable of blocking some rays of the outdoor sunlight, and other rays of the outdoor sunlight can enter indoors by transmitting through the sparsely textured portion of the window. The term “densely textured portion of a window shade”, used herein refers to a portion of a window shade which provides a light blocking effect better than the sparsely textured portion. The figures of the present invention clearly show the difference between the sparsely textured portion and the densely textured portion, and the densely textured portion depicted in the embodiments shown in the figures can block the outdoor sunlight from entering indoors. However, the present invention is not limited to these embodiments shown, which can be appreciated by one having ordinary skill in the art.

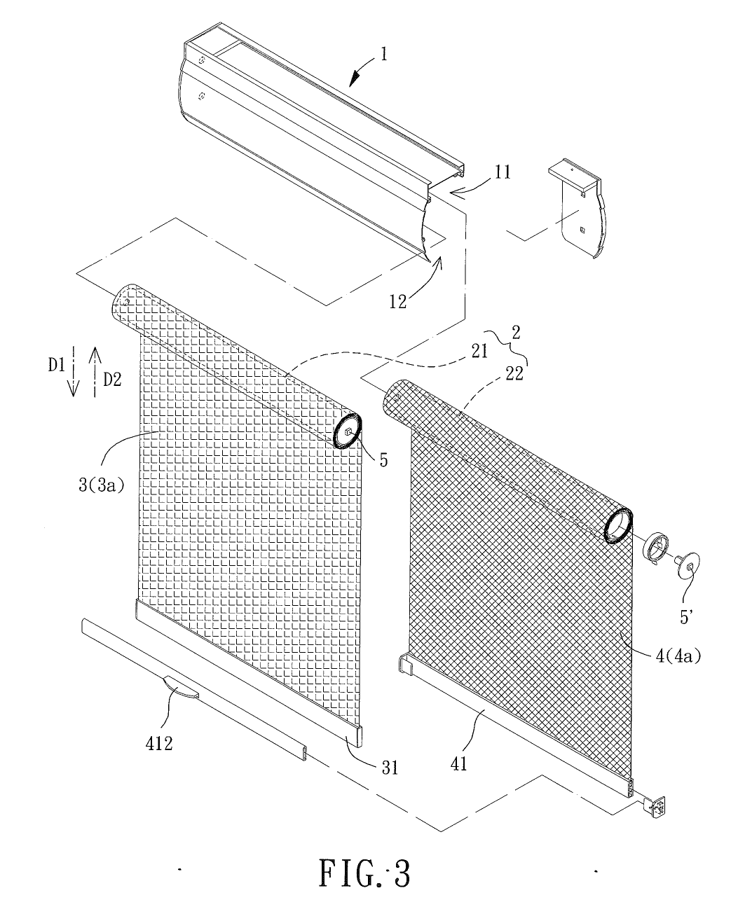

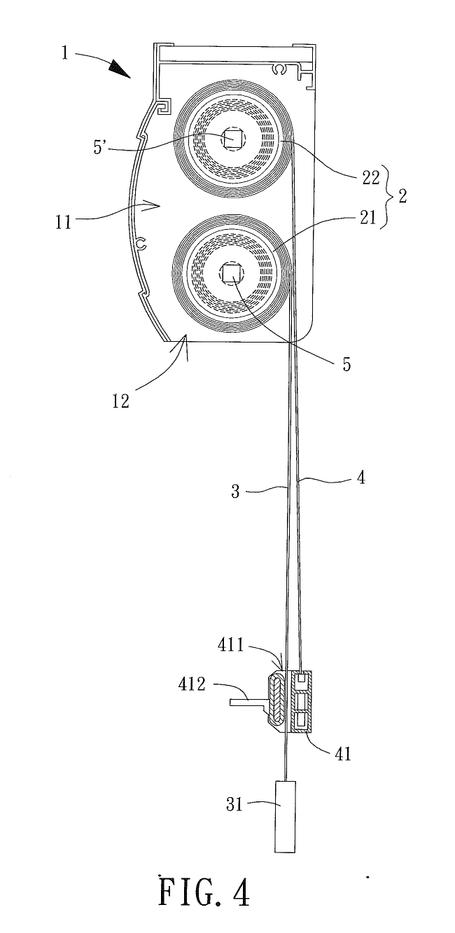

With reference to FIGS. 3 and 4, a light input-adjustable window shade of a first embodiment according to the present invention includes a supporting member 1, a spool unit 2, a first shade 3, and a second shade 4.

The supporting member 1 includes a chamber 11 for receiving the first shade 3 and the second shade 4. The supporting member 1 further includes an opening 12 intercommunicating the chamber 11 with an outside. A user can unfold each of the first and second shades 3 and 4 in an unfolding direction D1 via the opening 12 and can fold each of the first and second shades 3 and 4 into the chamber 11 in a folding direction D2 opposite to the unfolding direction D1 via the opening 12. In the first embodiment, the supporting member 1 is mounted to a top edge of a door or window, and the opening 12 faces the ground. In this case, the unfolding direction D1 is the direction from the top edge of the door or window towards the ground, and the folding direction D2 is the direction from the ground towards the top edge of the door or window.

The spool unit 2 is mounted to two opposite ends of the supporting member 1 and includes a first spool 21 and a second spool 22. The first and second spools 21 and 22 are rotatably received in the chamber 11.

An end of the first shade 3 is fixed to the first spool 21. When the first shade 3 is folded in the folding direction D2, the first shade 3 is wound around the first spool 21. The portion of the first shade 3 wound around the first spool 21 is received in the chamber 11.

The first shade 3 can be folded or unfolded by a first transmission and coiling device 5. Namely, the first transmission and coiling device 5 is connected to the first spool 21 for diving the first spool 21 to rotate, such that the other end of the first shade 3 not connected to the first spool 21 can be unfolded in the unfolding direction D1 via the opening 12 and can be positioned at a desired height that can be used to determine the area of the door or window covered by the first shade 3. On the other hand, the first transmission and coiling device 5 can be actuated to fold the first shade 3 in the folding direction D2, such that the first shade 3 is wound around the first spool 21 and is received in the chamber 11. The first transmission and coiling device 5 can be of a type shown in FIG. 3 of U.S. Patent Application Publication No. 2011/0036516. However, the present invention is not limited to this.

A first weight 31 can be fixed to the other end of the first shade 3 not connected to the first spool 21. The first weight 31 assists in smooth unfolding of the first shade 3.

The structure of the second shade 4 can be substantially the same as the first shade 3. Specifically, an end of the second shade 4 is fixed to the second spool 22. The second shade 4 can be folded or unfolded by a second transmission and coiling device 5′. The structure of the second transmission and coiling device 5′ can be the same as the first transmission and coiling device 5. The connection between the second transmission and coiling device 5′ and the second shade 4 can be the same as the connection between the first transmission and coiling device 5 and the first shade 3. The other end of the second shade 4 not connected to the second spool 22 can be unfolded in the unfolding direction D1 via the opening 12 and can be positioned at a desired height that can be used to determine the area of the door or window covered by the second shade 4. On the other hand, the second transmission and coiling device 5′ can be actuated to fold the second shade 4 in the folding direction D2, such that the second shade 4 is wound around the first spool 21 and is received in the chamber 11.

Furthermore, a second weight 41 can be fixed to the other end of the second shade 4. The second weight 41 assists in smooth unfolding of the second shade 4. In the first embodiment, the second weight 41 includes a slit 411, and the first shade 3 extends through the slit 411. Thus, the first shade 3 and the second shade 4 are spaced by a determined spacing, providing the first and second shades 3 and 4 with a synergistic light blocking effect.

The second weight 41 can include a gripping portion 412, and the slit 411 is located between the gripping portion 412 and the second shade 4. The user can grip the second shade 4 by the gripping portion 412 while adjusting the position of the second shade 4.

The outlines of the first shade 3 and the second shade 4 are not limited. It is noted that the first shade 3 includes at least one first sparsely textured portion 3a, and the second shade 4 includes at least one first densely textured portion 4a. At least a portion of the at least one first densely textured portion 4a is located relative to the at least one first sparsely textured portion 3a.

As an example, in the first embodiment shown in FIG. 3, the first shade 3 includes only one first sparsely textured portion 3a (namely, the whole first shade 3 has the same transmittance, and the rays of the outdoor sunlight can enter indoors through any portion of the first shade 3), and the second shade 4 includes only one first densely textured portion 4a (namely, the whole second shade 4 has the same transmittance, and any portion of the second shade 4 provides a better light blocking effect than the first shade 3). Since the at least one first sparsely textured portion 3a and the first densely textured portion 4a have different light blocking effects, the light input of the outdoor sunlight entering indoors can be adjusted by overlapping of the first and second shades 3 and 4, providing different indoor brightnesses.

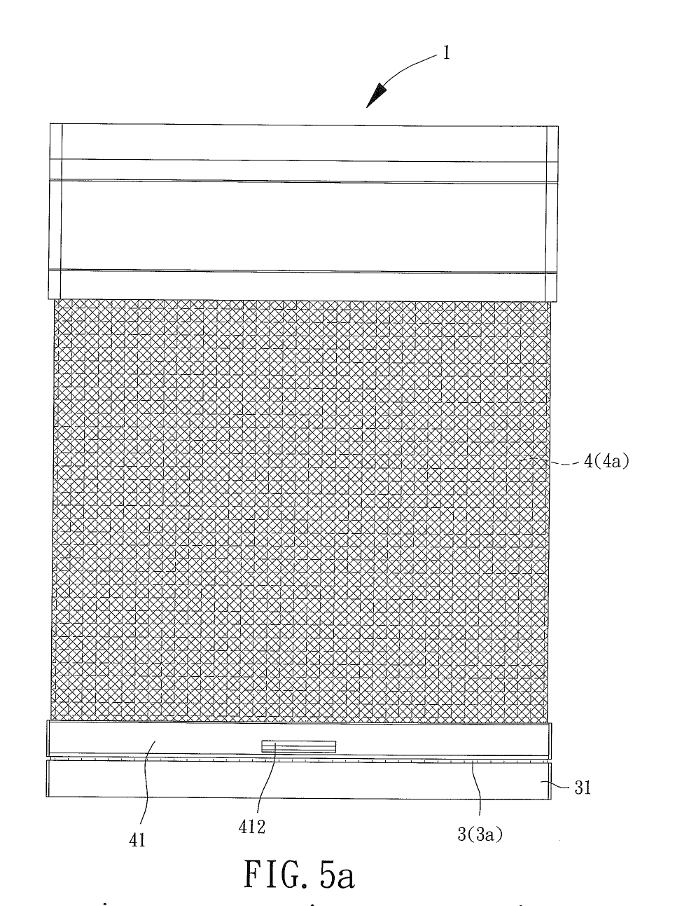

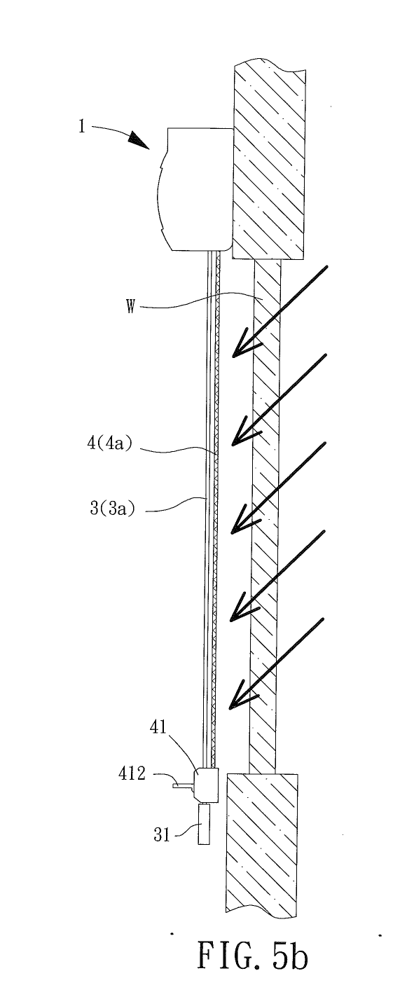

With reference to FIGS. 5a and 5b, in use of the first embodiment, the light input-adjustable window shade can be mounted to an inner side (namely, indoors) of a door or window W, and the user can simultaneously unfold the first and second shades 3 and 4 and can position the first and second shades 3 and 4 at the desired level. In this case, the first sparsely textured portion 3a and the first densely textured portion 4a, which are overlapped with each other, block a larger amount of outdoor sunlight to reduce the light input, such that the indoor brightness is low.

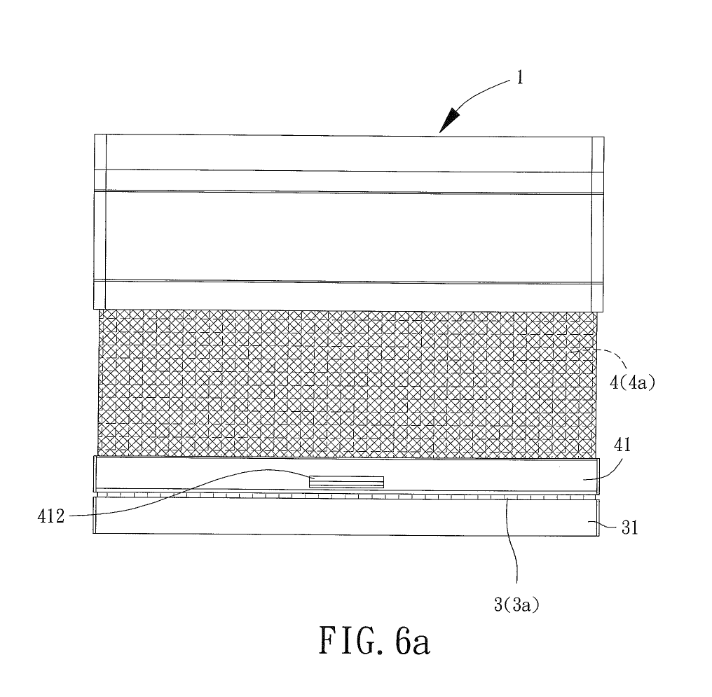

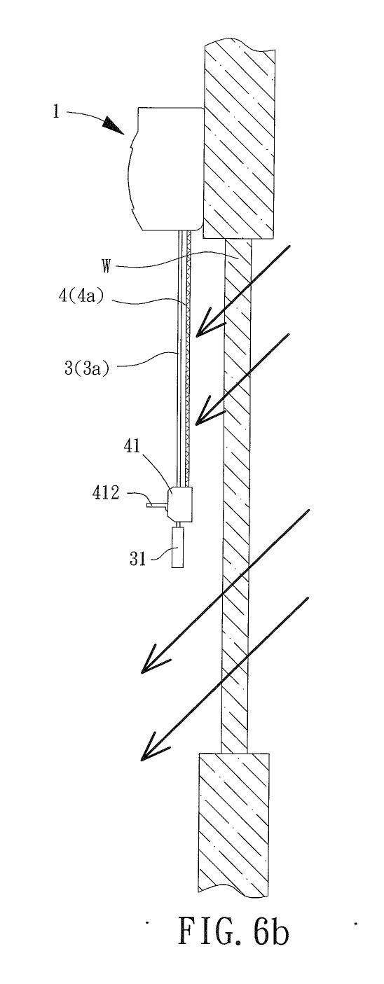

With reference to FIGS. 6a and 6b, the user can wind a portion of the first shade 3 around the first spool 21 and wind a portion of the second shade 4 around the second spool 22, and the wound portions of the first and second shades 3 and 4 are received in the chamber 11. In this case, since the lower portion of the door or window W (adjacent to the lower edge of the door or window W) is not covered by either the first sparsely textured portion 3a of the first shade 3 or the first densely textured portion 4a of the second shade 4, the rays of the outdoor sunlight can enter indoors directly through the door or window W (namely, the lower portion of the door or window has the maximum light input). Thus, the indoor area adjacent to the door or window W is brighter. Furthermore, another indoor area distant to the door or window W is less bright, because the upper portion of the door or window W (adjacent to the top edge of the door or window W) is covered by the first sparsely textured portion 3a of the first shade 3 and the first densely textured portion 4a of the second shade 4.

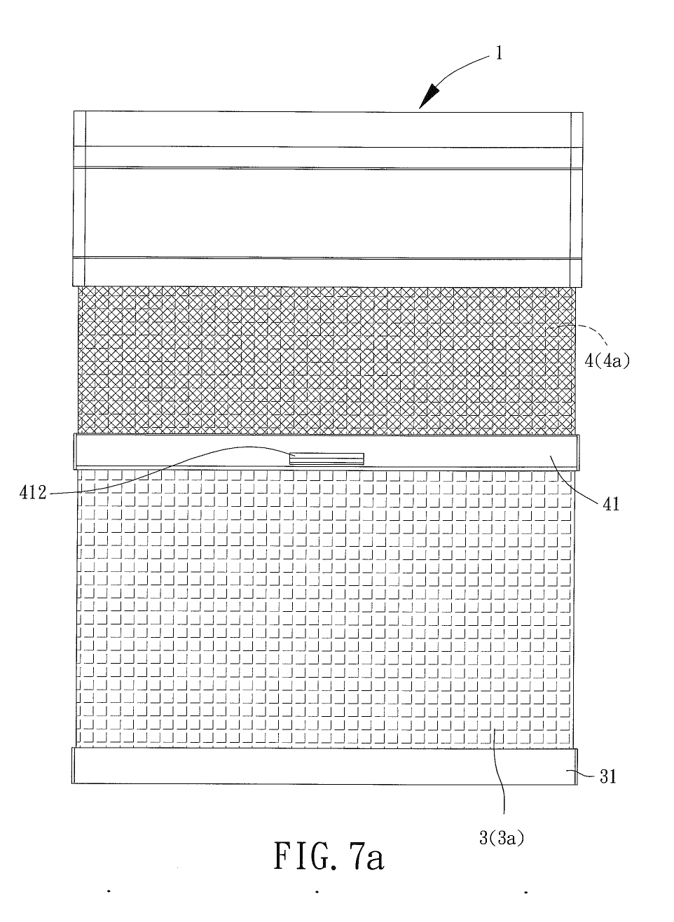

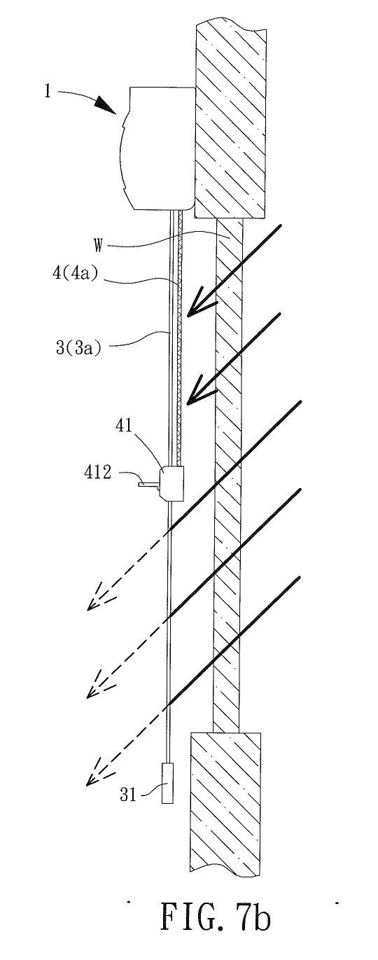

With reference to FIGS. 7a and 7b, the user can maintain the portion of the second shade 4 wound around the second spool 22 and can unfold the first shade 3 to completely cover the door or window W. In this case, compared to the situation shown in FIGS. 6a and 6b, although the indoor area distant to the door or window W is maintained in the low-brightness state, the brightness of the indoor area adjacent to the door or window W can be weakened, because the first sparsely textured portion 3a of the first shade 3 only permits a portion of the rays of the outdoor sunlight to enter indoors via the lower portion of the door or window W (namely, the light input of the outdoor sunlight entering indoors via the lower portion of the door or window W is reduced). Thus, the brightness of the indoor area adjacent to the door or window W shown in FIGS. 6a and 6b can be slightly reduced.

The first shade 3 and the second shade 4 can have other forms.

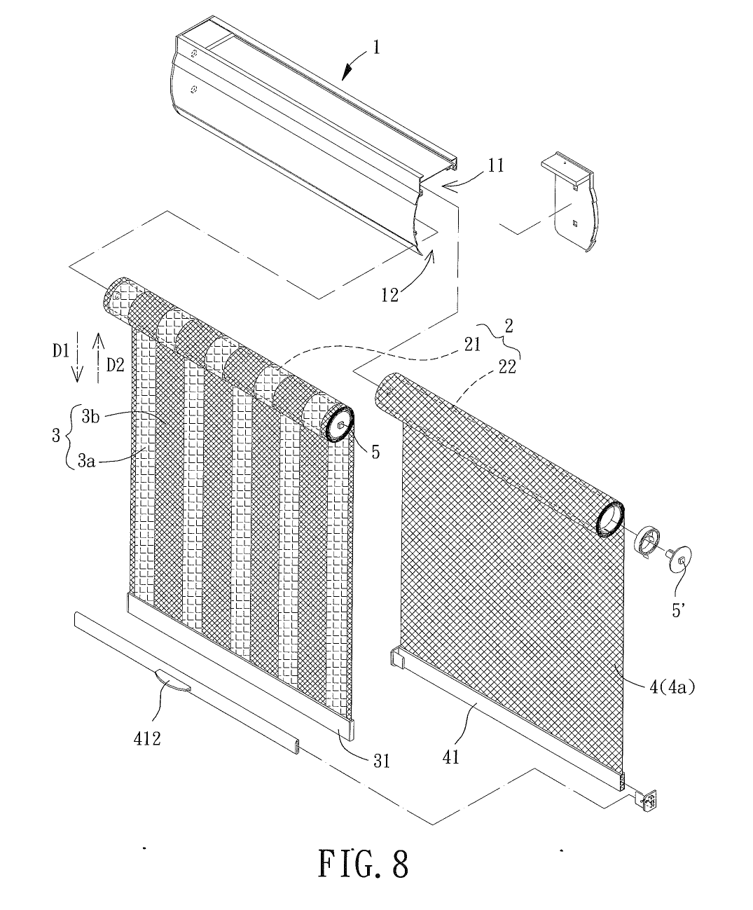

In a second embodiment shown in FIG. 8, the first shade 3 includes a plurality of first sparsely textured portions 3a and a plurality of second densely textured portions 3b. The first sparsely textured portions 3a alternate with the second densely textured portions 3b in a vertical stripe arrangement. Like the first embodiment, the second shade 4 includes only one first densely textured portion 4a. A portion of the first densely textured portion 4a of the second shade 4 is located relative to the first sparsely textured portions 3a.

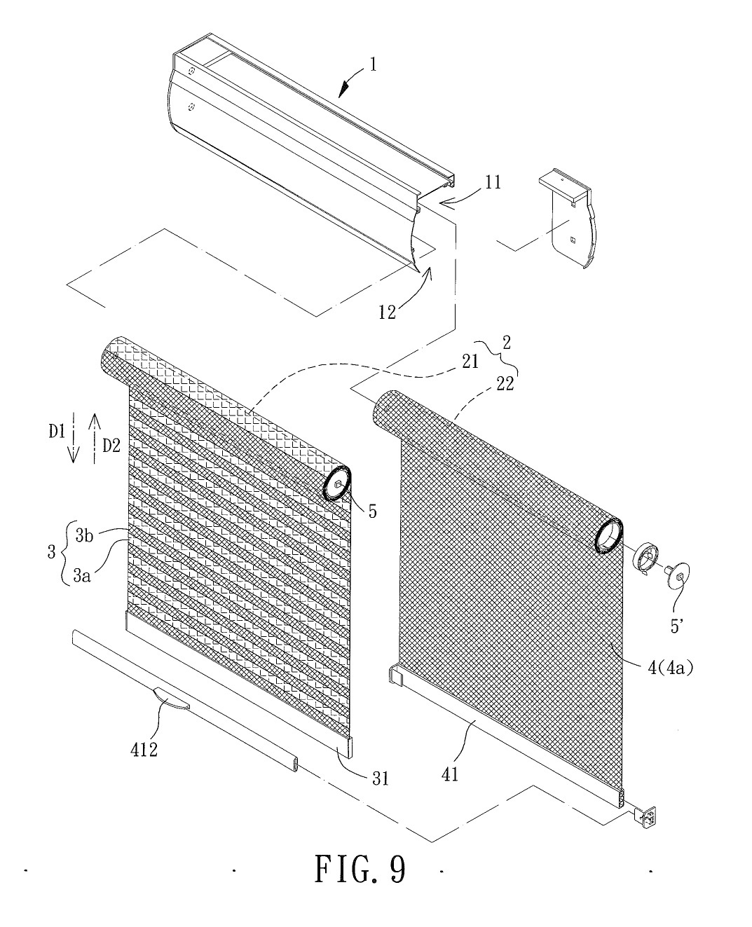

In a third embodiment shown in FIG. 9, the structures of the first and second shades 3 and 4 are substantially the same as those of the second embodiment, except that the first sparsely textured portions 3a alternate with the second densely textured portions 3b in a horizontal stripe arrangement.

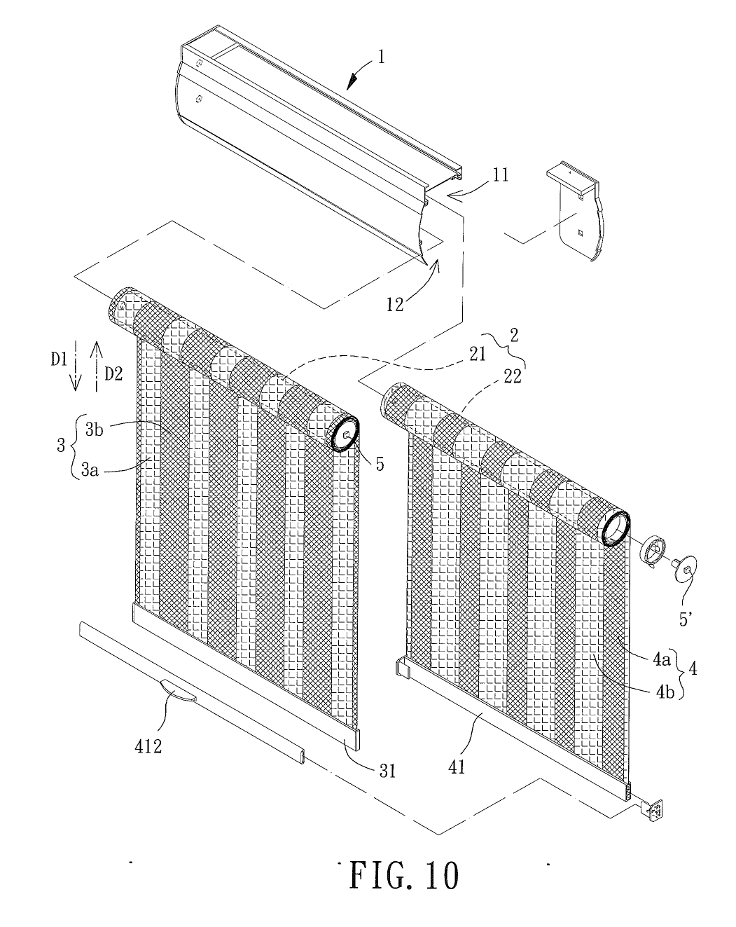

In a fourth embodiment shown in FIG. 10, the first shade 3 includes a plurality of first sparsely textured portions 3a and a plurality of second densely textured portions 3b. The first sparsely textured portions 3a alternate with the second densely textured portions 3b in a vertical stripe arrangement. The second shade 4 includes a plurality of first densely textured portions 4a and a plurality of second sparsely textured portions 4b. The first densely textured portions 4a alternate with the second sparsely textured portions 4b in a vertical stripe arrangement.

The first densely textured portions 4a and the second sparsely textured portions 4b of the second shade 4 are located relative to the first sparsely textured portions 3a and the second densely textured portions 3b of the first shade 3.

In view of the foregoing, in the light input-adjustable window shade according to the present invention, the first shade 3 and the second shade 4 can be unfolded in the unfolding direction D1 or folded in the folding direction D2 by respectively using the first transmission and coiling device 5 and the second transmission and coiling device 5′ to adjust the area of the door or window W covered by the first shade 3 and the second shade 4. Furthermore, the areas covered by the first shade 3 and the second shade 4 can be different (see FIGS. 6a, 6b, 7a, and 7b) to adjust the brightness of the indoor area adjacent to the door or window W and the brightness of the indoor area distant to the door or window W.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

What is claimed is:

1. A light input-adjustable window shade comprising:
a supporting member having two ends opposite to each other;
a spool unit mounted to the two ends of the supporting member, with the spool unit including a first spool and a second spool;
a first shade including an end fixed to the first spool, with the first shade unfoldable in an unfolding direction through operation of a first transmission and coiling device or foldable in a folding direction through operation of the first transmission and coiling device; and
a second shade including an end fixed to the second spool, with the second shade unfoldable in the unfolding direction through operation of a second transmission and coiling device or foldable in the folding direction through operation of the second transmission and coiling device,
wherein the first shade includes at least one first sparsely textured portion, the second shade includes at least one first densely textured portion, and at least a portion of the at least one first densely textured portion is located relative to the at least one first sparsely textured portion.

2. The light input-adjustable window shade as claimed in claim 1, further comprising: a first weight fixed to another end of the first shade; and a second weight fixed to another end of the second shade.

3. The light input-adjustable window shade as claimed in claim 2, wherein the second weight includes a slit, and the first shade extends through the slit.

4. The light input-adjustable window shade as claimed in claim 3, wherein the second weight includes a gripping portion, and the slit is located between the gripping portion and the second shade.

5. The light input-adjustable window shade as claimed in claim 1, wherein the supporting member includes a chamber, and the first and second spools are rotatably received in the chamber.

6. The light input-adjustable window shade as claimed in claim 5, wherein the supporting member further includes an opening intercommunicating the chamber with an outside, and each of the first and second shades is unfoldable in the unfolding direction via the opening and is foldable in the folding direction via the opening.

7. The light input-adjustable window shade as claimed in claim 1, with the at least one first sparsely textured portion of the first shade including a plurality of first sparsely textured portions, with the first shade further including a plurality of second densely textured portions, and with the plurality of first sparsely textured portions alternating with the plurality of second densely textured portions in a stripe arrangement.

8. The light input-adjustable window shade as claimed in claim 7, with the at least one first densely textured portion of the second shade including a plurality of first densely textured portions, with the second shade further including a plurality of second sparsely textured portions, and with the plurality of first densely textured portions alternating with the plurality of second sparsely textured portions in a stripe arrangement.

9. The light input-adjustable window shade as claimed in claim 8, wherein the plurality of first densely textured portion and the plurality of second sparsely textured portions of the second shade are respectively located relative to the plurality of first sparsely textured portions and the plurality of second densely textured portions of the first shade.
